(19) United States
(12) Patent Application Publication
(10) Pub. No.: US 2022/0222432 A1
(43) Pub. Date: Jul. 14, 2022

(54) RECOMMENDING THEME PATTERNS OF A DOCUMENT

(71) Applicant: Microsoft Technology Licensing, LLC, Redmond, WA (US)

(72) Inventors: Si Meng, Beijing (CN); Tao Wu, Redmond, WA (US); Siliang Pi, Redmond, WA (US); Fangrong Chen, Redmond, WA (US); Jinge Yao, Redmond, WA (US)

(21) Appl. No.: 17/609,686

(22) PCT Filed: Apr. 21, 2020
(86) PCT No.: PCT/US2020/029041

§ 371 Date: Nov. 8, 2021

(30) Foreign Application Priority Data
Jun. 6, 2019 (CN) 201910493328.4

(51) Int. Cl. G06F 40/186; G06F 40/103; G06V 30/41; G06F 16/583; G06F 3/0482

(52) U.S. Cl. CPC G06F 40/186; G06F 40/103; G06F 3/0482; G06F 16/583; G06V 30/41

(57) ABSTRACT

The disclosure provides a method for recommending theme patterns of a document. In some embodiments, a trigger for providing theme patterns may be detected. Current content of the document may be identified. At least one theme pattern related to the current content of the document may be provided.

### BACKGROUND

With the rapid development of computer systems, people are increasingly using electronic documents to convey information. When creating an electronic document, a creator or a designer of the document can apply a theme pattern to the document to quickly beautify and unify style of the document.

### SUMMARY

This Summary is provided to introduce a set of concepts that are further described below in the Detailed Description. It is not intended to identify key features or essential features of the claimed subject matter, nor is it intended to be used to limit the scope of the claimed subject matter.

An embodiment of the disclosure provides a method for recommending theme patterns of a document. In the method, a trigger for providing theme patterns may be detected. Current content of the document may be identified. At least one theme pattern related to the current content of the document may be provided.

It should be noted that the above one or more aspects include the following detailed description and features specifically pointed out in the claims. The following description and the appended drawings set forth in detail certain illustrative features of the one or more aspects. These features are merely indicative of various ways in which the principles of the various aspects can be implemented, and the disclosure is intended to include all such aspects and equivalent transformations thereof.

### BRIEF DESCRIPTION OF THE DRAWINGS

The disclosed aspects will hereinafter be described in connection with the appended drawings that are provided to illustrate and not to limit the disclosed aspects.

FIG. 1 illustrates a conventional exemplary document interface.

FIG. 2 illustrates an exemplary process for recommending theme patterns of a document according to an embodiment.

FIGS. 3A-3B illustrate an exemplary document interface generated according to the exemplary process of FIG. 2.

FIG. 4 illustrates another exemplary process for recommending theme patterns of a document according to an embodiment.

FIG. 5 illustrates an exemplary document interface generated according to the exemplary process of FIG. 4.

FIGS. 6A-6B are exemplary document interfaces displaying a theme pattern applied in different devices according to an embodiment.

FIG. 7 illustrates an exemplary process for recommending a plurality of theme patterns for a same document according to an embodiment.

FIG. 8 illustrates an exemplary document interface generated according to the exemplary process of FIG. 7.

FIG. 9 illustrates still another exemplary process for recommending theme patterns of a document according to an embodiment.

FIG. 10 illustrates an exemplary document interface generated according to the exemplary process of FIG. 9.

FIG. 11 illustrates a flowchart of an exemplary method for recommending theme patterns of a document according to an embodiment.

FIG. 12 illustrates an exemplary apparatus for recommending theme patterns of a document according to an embodiment.

FIG. 13 illustrates another exemplary apparatus for recommending theme patterns of a document according to an embodiment.

### DETAILED DESCRIPTION

The present disclosure will now be discussed with reference to various exemplary embodiments. It should be understood that the discussion of the embodiments is merely intended to enable a person skilled in the art to better understand and thus practice the embodiments of the present invention, and not to teach any limitation of the scope of the disclosure.

In order to present a document with a beautifying effect and a uniform style, a creator of the document usually applies a theme pattern to the document when creating the document. Currently, a creator of a document generally applies the following ways when applying a theme pattern to the document: selecting a desired theme pattern from a plurality of preset or recommended candidate theme patterns, searching for a desired theme pattern on the Internet, or uploading the desired theme pattern by oneself.

Embodiments of the disclosure propose a method and an apparatus for recommending theme patterns of a document, which may detect a trigger for providing theme patterns; identify current content of the document and/or other information related to the document; and provide at least one theme pattern related to the current content of the document. According to an embodiment of the disclosure, the theme pattern that matches the document may be automatically recommended when the document is created, and the recommended theme pattern may be automatically updated as content of the document changes. The automatic recommendation and automatic update of the theme pattern can save time for the creator of the document to determine the theme pattern, so that the creator does not have to manually find, search or upload a desired theme pattern. In addition, according to an embodiment of the disclosure, recommendation and/or update of a theme pattern is based on current content of a document, and after the content of the document being edited, updated, or changed, the recommended or provided theme pattern will change accordingly, so that the recommended or provided theme pattern will be more closely relevant to the current content of the document, thereby a receiver of the document will have a better experience of viewing, usage, or reviewing.

Herein, documents may include, but are not limited to, PPT documents, Word documents, Excel documents, forms, and so on. In the following and the drawings, for the convenience of description, a form is used as an example to describe the embodiments of the disclosure; however, it should be noted that the solution of this application may also be applied to any other documents.

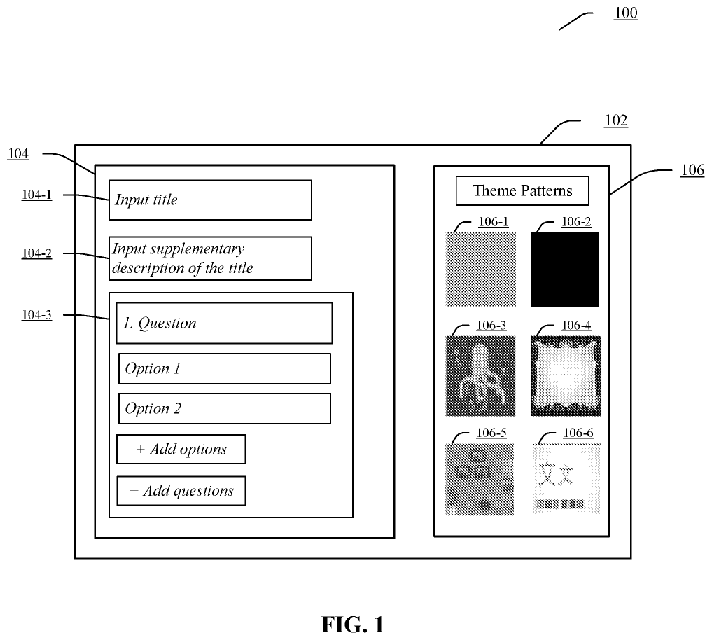

FIG. 1 illustrates a conventional exemplary document interface 100. In this example, a form is described as the exemplary document. In the exemplary document interface 100 of FIG. 1, a canvas 104 and a theme pattern area 106 of a form are presented in a window 102. In this embodiment, several elements of the document are presented on the canvas 104, such as a title 104-1 of the form, a supplementary description for the title 104-2 and a main body 104-3, etc., where the main body 104-3 in this embodiment is exemplified as questions and options, but in other examples, the main body may also be shown as a presentation, a text portion of a Word document, and so on. In other embodiments, the canvas 104 may present more or fewer elements according to actual needs. In this embodiment, the theme pattern area 106 is used to present candidate theme patterns from a preset theme pattern library, which are set in advance and are not necessarily associated with the content in the form, and will not change as the content of the form changes. In this embodiment, the theme pattern area 106 may present theme patterns 106-1, 106-2, 106-3, 106-4, 106-5, 106-6 as shown. It should be noted that although the exemplary theme patterns 106-1 to 106-6 are shown as icons in the form of images in the figure, in some examples, they may also be in the form of multi-dimensional labels and each dimension of a label may indicate one of background of the window 102 presenting the form, background of the canvas 104, color of the canvas 104, a format of text presenting on the canvas 104, for example, a format of the text in title 104-1, a supplementary description for the title 104-2, or main body 104-3.

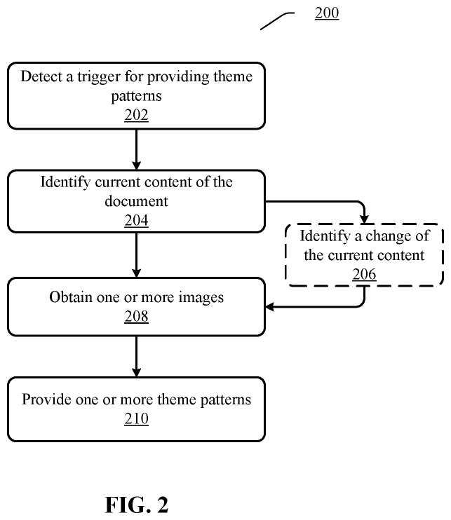

FIG. 2 illustrates an exemplary process 200 for recommending theme patterns of a document according to an embodiment.

In block 202, a trigger for providing a theme pattern may be detected, such as an activation operation to the document, an input operation of a user to a document, reception of a request for providing theme patterns, and so on. In some examples, an activation operation to the document may include a user opening a document application or creating a document through the document application, and so on. In some examples, an input operation of a user to a document may include various editing operations made by the user to the text of the document, such as adding, deleting and modifying the content of the text portion on the canvas; setting and changing the font, size and color of words in the text, and so on. In other examples, reception of a request for providing theme patterns may include receiving a user's click, touch, selection, etc. on a theme pattern item in a document. A user herein may also be referred to as a creator, designer, editor, etc. of a document.

In response to detecting a trigger at 202, the current content in the document may be identified at block 204. In some examples, the current content of the document may include, but is not limited to, any of: text in the document, format of the text, keywords in the document, language used in the document, and so on.

At block 208, one or more images may be obtained, for example, according to the identified current content. In some examples, the obtained image is retrieved from an image database or generated according to text of the current content of the document.

In some examples, the images in the image database may have multi-dimensional labels, so that the corresponding images are retrieved by matching the identified current content with the labels of the images in the database. In other examples, one or more candidate images corresponding to inputted content may be obtained through an image recommendation model. For example, the image recommendation model may be a machine learning model trained by assigning one or more labels, such as attribute labels, to each image or a group of images of the image database or data pool; automatically attaching labels to received input or obtained information; and recommending an image with a label that is the same as or matches a label of the received input. In some examples, the received input or obtained information may comprise information related to the document, such as, but not limited to a title of the document, content of the main body of the document, language used in the document, keywords in the document, topics involved in the document, and profile of a creator and/or receiver of the document. For example, when a user inputs the text “Birthday Party Invitation” as the title of the form, the received input may be attached with labels “Birthday Party”, “Invitation”, and one or more images or one or more groups of images with the same or corresponding labels in the database will be recommended. For example, if keyword in the document is “food” and the used language is Chinese, images coinciding with Chinese food, such as images with hot pot, rice, noodles, soup, etc. may be obtained or recommended; if keyword in the document is “food” and the used language is English, pictures coinciding with western food such as pizza, burger, sandwich, etc. may be obtained or recommended.

In other examples, a conditional generation model, such as a text-to-image generation model, may be used to generate one or more images according to the text of the current content of the document. The text-to-image generation model may adopt standard generation models, such as, but not limited to, Attention Generative Adversarial Networks (GAN), Stack GAN, etc., so that images may be automatically generated from a given text content. In this embodiment, training data of the text-to-image generation model may be a large number of <text, image> pairs. During training, the text may be used as input to the text-to-image generation model in the form of labels or attribute-value pairs, and the text-to-image generation model may output a corresponding image in an end-to-end manner. For example, labels of the text may be “food”, “female”, “Microsoft”, etc., and the attribute-value pair of the text may be “score-five stars”, “age=27”, and so on.

After obtaining one or more candidate images through any of the above approaches, a machine learning model may be used to automatically score or rank candidate images using features extracted from the text, and consider the first K (K is any positive integer, such as K=3) images as images included in a recommended theme pattern. In some examples, candidate images may be collected from any one or more of: most frequently used images in a database, images previously selected by a user, images generated from text of a document through a text-to-image generation model.

Optionally, at block 206, changes in the current content may be identified. For example, the changes may include, but are not limited to, addition, deletion, modification of text content, changes in font, size, color of words, and so on. Further, one or more images may be obtained at block 208 according to changes in the current content.

At block 210, one or more theme patterns may be provided according to the obtained images. In some examples, the theme pattern may comprise one or more of background of a window of the document, background of a canvas of the document, format of text presented on the canvas, identification presented on the canvas, wherein the identification is associated with at least one of current content of the document, a creator of the document, a receiver of the document. In some examples, providing one or more theme patterns may include generating theme patterns according to the obtained image, such as generating one or more of: background of a window of the document, background of a canvas of the document, and format of text in the document. In some examples, providing one or more theme patterns may further include retrieving or generating the identification according to at least one of current content of the document, profile of a creator of the document, and profile of a receiver of the document, such as logo, trademark of a company, representative avatar of a user, etc.

In some embodiments, a theme pattern may be generated to include at least one of: a displayed image being used as the background of the window, a portion extracted from an image (for example, a portion of interest) being used as the background of the canvas, a main color extracted from an image or a color that is opposite or complementary to the main color being used as the color of the canvas, the font, size, and color of the text set in this theme pattern being used as the format of text, and so on. For example, the theme pattern defines the background image of the window, the font, size, color of the text on the canvas, and so on.

Further, in some examples, after one or more theme patterns are provided to a user or a creator of the document, the user may select a theme pattern to apply to the document. In other examples, any one of the generated or provided theme patterns or the highest-ranked theme pattern may be directly applied to the document without being provided to the user for selection.

For ease of explanation and simplicity, take the form as an example in the following to illustrate the document interface generated according to the concepts of the application. It is to be understood that the concepts of this application may also be applied to other types of documents.

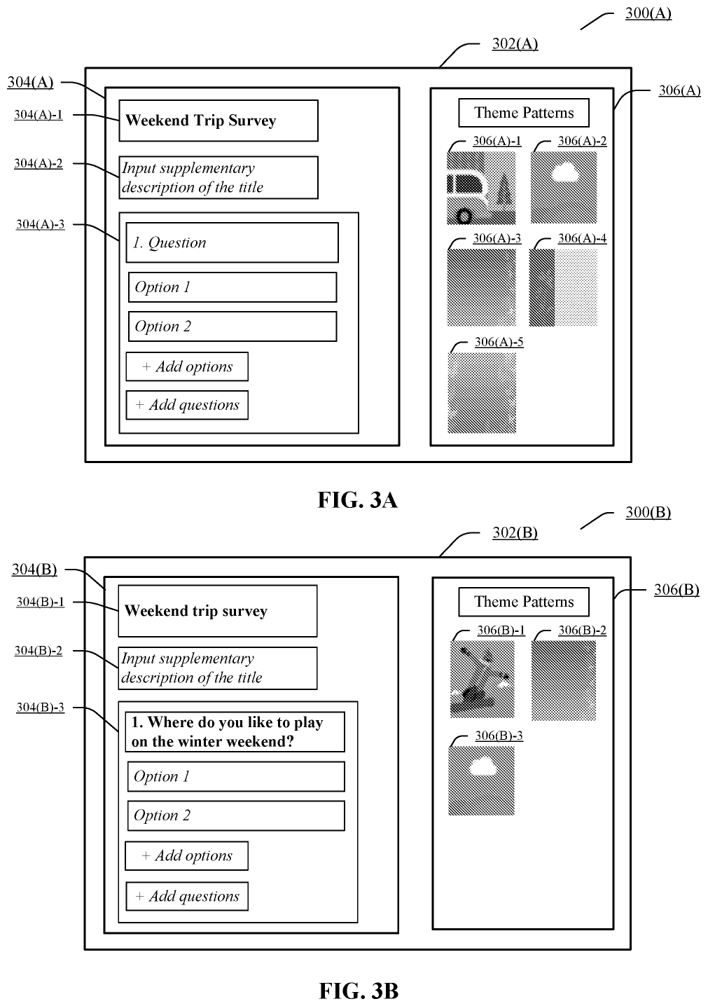

FIGS. 3A-3B illustrate an exemplary document interfaces 300(A) and 300(B) generated according to the exemplary process of FIG. 2.

Shown in the document interface 300(A) is a canvas 304(A) presenting the document and a window 302(A) of the theme pattern area 306(A). Different elements of the document are shown on the canvas 304(A), such as a title 304(A)-1, a supplementary description of the title 304(A)-2, and a main body 304(A)-3. It should be understood that multiple elements shown on the canvas are merely exemplary, and there may be more or fewer elements on the canvas.

As shown in 304(A)-1, the user inputs the text content “Weekend Trip Survey” in the title section of the form. That is, user input to the form may be detected. According to the current content in the identified document, such as “weekend”, “trip”, “survey”, one or more images related to the content may be obtained and one or more theme patterns containing the one or more images may be provided, such as the theme patterns 306(A)-1, 306(A)-2, 306(A)-3, 306(A)-4, 306(A)-5 presented in the theme pattern area 306(A). According to the images contained in the theme patterns 306(A)-1 to 306(A)-5, it may be seen that the above theme patterns are all related to the content “trip”. For example, the image contained in the theme mode 306(A)-1 describes cars, tall buildings, and trees, which can be attached with a multi-dimensional label, such as [trip, outdoor, car], etc.; the image contained in the theme mode 306(A)-2 describes mountains and white clouds, which can be attached with a multi-dimensional label, such as [mountain climbing, trip, outdoor, mountain peaks, white clouds, sunny weather] etc.; the image contained in the theme mode 306(A)-3 describes snowflakes, which can be attached with a multi-dimensional label, such as [snowflakes, cold, winter, going out or trip], etc.; the image contained in the theme mode 306(A)-4 describes flowers, which can be attached with a multi-dimensional label, such as [flowers, spring, spring tour, going out or trip], etc.; the image contained in the theme mode 306(A)-5 describes butterflies, which can be attached with a multi-dimensional label, such as [butterflies, spring, spring tour, going out or trip], etc. A corresponding image for the current content may be obtained by matching the current content of the document with the label of the image in the theme pattern or using a pre-trained machine learning model, thereby a corresponding theme pattern may be generated. It should be noted that the images in respective theme pattern may be attached with multi-dimensional labels in any suitable manner, for example, the labels may be attached by manual labeling or the labels may be automatically generated by machine learning. In some examples, any suitable ranking method or scoring method may be used to rank the theme patterns containing the obtained images, such as ranking each theme pattern 306(A)-1, 306(A)-2, 306(A)-3, 306(A)-4, 306(A)-5 in the theme pattern area 306(A).

Further, as the user continues to input or edit on the canvas, the content of the document changes, and the provided theme pattern is updated, as shown in the exemplary document interface 300(B) with reference to FIG. 3B. As shown in FIG. 3B, in the window 302(B) presenting the document, a canvas 304(B) including a plurality of elements (for example, a title 304(B)-1, a supplementary description for the title 304(B)-2, and a main body 304(B)-3) and a theme pattern area 306(B) presenting a plurality of theme patterns 306(B)-1, 306(B)-2, and 306(B)-3 are shown. In this example, it may be recognized that the current content of the document has changed compared to the content in FIG. 3A, for example, the new content “Where do you like to play on the winter weekend?” is input at the main body 304(B)-3. At least according to the inputted new content, such as “Winter”, “Weekend”, “Like”, “Where to play”, the image is re-obtained and an updated theme pattern is provided or recommended based on the obtained image. For example, at least according to the labels “Winter” and/or “Where to play” in the content, candidate images related to winter play are obtained, and a theme pattern including the first K (e.g., the first three) highest ranked images are provided. For example, if candidate image 1 in the image database describes a person skiing and has the label [winter, skiing, playing, happy, skateboarding, snowboarding], etc., the candidate image 1 may be used as the first-ranked image by any suitable scoring or ranking method, and a theme pattern including the candidate image 1 is provided, for example, the theme pattern 306(B)-1. As another example, if candidate image 2 in the image database describes snowflakes and has the label [winter, snowflake, cold], etc., the candidate image 2 may be used as the second-ranked image by any suitable scoring or ranking method, and a theme pattern including the candidate image 2 is provided, for example, the theme pattern 306(B)-2, and so on.

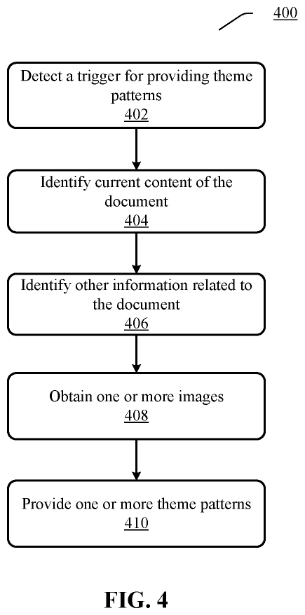

FIG. 4 illustrates another exemplary process 400 for recommending theme patterns of a document according to an embodiment.

At block 402, a trigger for providing theme patterns may be detected, which is similar to operation at block 202. In this embodiment, the process 400 is described with user input to a document as an example of the trigger.

At block 404, current content of the document may be identified in response to detecting trigger at block 402, which is similar to operation at block 204.

At block 406, other information related to the document may be identified. In some examples, the other information related to the document may include, but is not limited to, one or more of a profile of a creator of the document, a history usage record of the creator with respect to theme patterns, a profile of a receiver of the document, and information for target entities of the document determined from other applications. In some examples, a profile of a creator of the document or a profile of a receiver of the document may include, but is not limited to: gender, age, location, preference, name of the company, position, company size, department, industry of the company, and so on. In some examples, a history usage record of the creator with respect to theme patterns may be saved in a history database or may be incorporated into the profile of the creator as history data or preferences. In some examples, other applications may include email applications, calendar applications, document editors, chat tools, etc. In some examples, target entities for the document may include topics involved in the document determined according to content from other applications, which may include time, place, event, etc., and/or language used in the document, and so on.

At block 408, one or more images may be obtained based at least on the identified current content of the document and other information related to the document, such as obtained by retrieving images from a database or generating images according to text. For example, if the identified content is about a survey for weekend trip, travel-related images may be retrieved or generated. For more examples, if the receiver of the document is a human resource department of a small multimedia company, images with lively style may be obtained; if the receiver of the document is a marketing department of a large airline company, images with serious style may be obtained. For more examples, if the creator or receiver is an employee of Microsoft Corporation, an image with a logo of Microsoft Corporation may be recommended; if preference of the creator is set to liking red, an image with a main color of red may be recommended; if location of the creator is in China, a Chinese-style image may be recommended, and so on.

At block 410, theme patterns may be provided according to the obtained images. For example, the obtained image may be used as a background of a window in the theme pattern, a color that is the same as, similar to or opposite to the color extracted from the obtained image may be used as the background color of the window or canvas in the theme pattern, the format of text in the theme pattern, such as font, color, size, etc., may be set based on the obtained image. For example, offline training may be used for obtaining a machine learning classification model for the format of text according to the image by employing a data set <image, format of text> pair. In some examples, multi-dimensional labels for the format of text may be output for a inputted image through a trained machine learning classification model, such as [font, size, color, etc.].

In some examples, after one or more theme patterns are provided to a user or a creator of a document, the user may select a theme pattern to apply to the document. In other examples, any one of the generated or provided theme patterns or a highest-ranked theme pattern may be directly applied to the document without being provided to the user for selection.

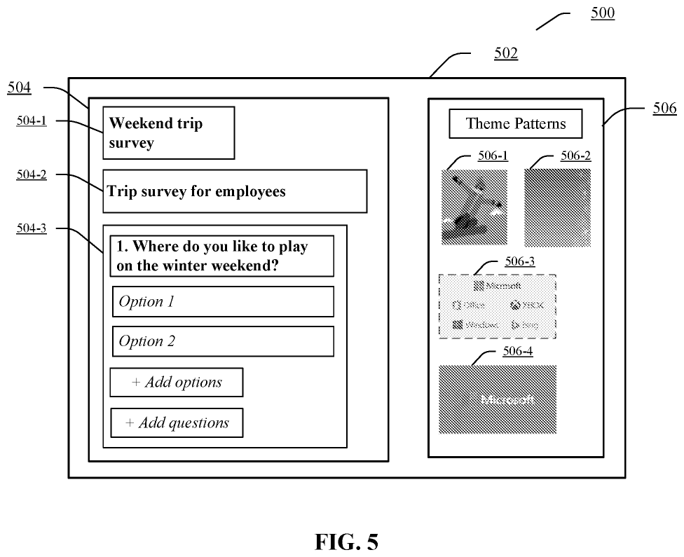

FIG. 5 illustrates an exemplary document interface 500 generated according to the exemplary process of FIG. 4. In this embodiment, other information related to the document may be information in the profile of the creator or receiver, for example, the creator or receiver is an employee of Microsoft Corporation.

Shown in the exemplary document interface 500 is a canvas 504 presenting the document and a window 502 of the theme pattern area 506. In some examples, different elements of the document are shown on canvas 504, such as the title 504-1 of the document “a survey for weekend trip”, a supplementary description of the title 504-2 “trip survey for employees”, main body 504-3 “Where do you like to play on the winter weekend?”. It should be understood that the multiple elements shown on the canvas are merely exemplary, and there may be more or fewer elements on the canvas.

According to the identification of the current content on the canvas 504, such as the text in the title 504-1, the supplementary description 504-2, and the main body 504-3, and further identification of other information about the document, such as the creator or receiver of the document is an employee of Microsoft Corporation, one or more images related to the current content and other information may be obtained and a corresponding theme pattern, such as 506-1 to 506-4 presented in the theme pattern area 506, may be provided.

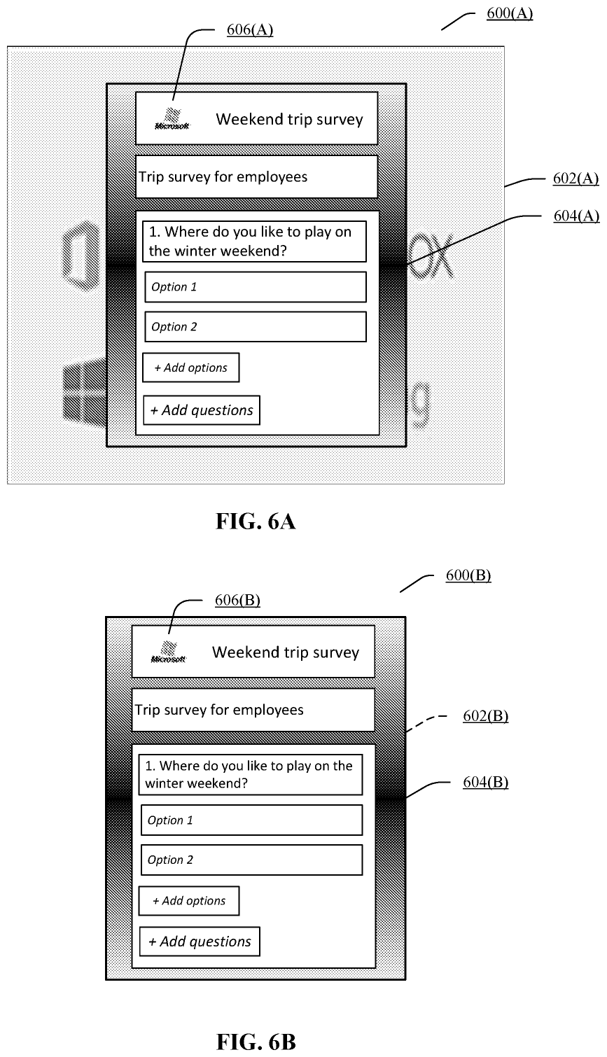

In some examples, the current content and other information of the document may be identified as having multi-dimensional labels. For example, in the example of FIG. 5, the current content of the document may be identified as [weekend trip, survey, employee, trip survey, winter, weekend, like, where to play], and other information related to the document may be identified as [Microsoft's employee]. One or more images are obtained at least according to the current content of the identified document and other information, and the obtained images are ranked by any suitable ranking approach, so that the theme pattern based on the first K images is provided or recommended to the user or creator. For example, a theme pattern based on an image obtained according to the current content may be ranked first, and a theme pattern based on an image obtained according to other information may be ranked behind. As shown in FIG. 5, theme patterns 506-1, 506-2 provided or recommended according to the current content “Winter”, “Where to play”, etc. are ranked first, theme patterns 506-3, 506-4 provided or recommended according to the information of the creator “Microsoft's employees” are ranked behind. In this example, when the theme patterns 506-1 to 506-4 are provided or recommended to the user, the user may select one of the theme patterns to apply to the document, for example, the theme pattern 506-3 shown in a dashed box is selected. In other examples, the ranked-first theme pattern may be applied directly to the document without the user making a choice. An exemplary document to which the theme pattern 506-3 is applied according to this embodiment may be as shown in FIGS. 6A to 6B below.

FIGS. 6A-6B are exemplary document interfaces 600(A) and 600(B) displaying an applied theme pattern 506-3 in different devices according to an embodiment. In different devices, according to a size of a display screen of a device, a window of a document may be displayed entirely, partially, or not.

As shown in FIGS. 6A and 6B, after a specific theme pattern such as 506-3 is selected to be applied to a document, the theme pattern of the document presented in the document interfaces 600(A) and 600(B) includes not only the background of the window, the background of the canvas, but also the font, size, color (not shown) of the text presented on the canvas, etc. In addition, the theme pattern of the document presented in the document interfaces 600(A) and 600(B) may further include an identification associated with at least one of the current content of the document, the creator of the document, and the receiver of the document, for example, an identification that is retrieved or generated according to the profile of the creator or receiver, such as a Logo displayed near the title on the canvas, such as Logo for Microsoft Corporation indicated by 606(A) in FIG. 6A and 606(B) in FIG. 6B. Although the identification is displayed near the title on the canvas in the examples of FIGS. 6A and 6B, it may be displayed at any position on the canvas.

Window 602(A) and canvas 604(A) are shown in an exemplary document interface 600(A), where background of the window 602(A) adopts an image included in the theme pattern 506-3, and where the image is partially displayed and partially covered by the canvas 604(A), and a color of the background of the canvas 604(A) adopts a color extracted from the image included in the theme pattern 506-3. In this example, the exemplary document interface 600(A) is presented on a device with a larger display screen, such as a desktop computer, a notebook computer, etc.

Canvas 604(B) is shown in an exemplary document interface 600(B). Due to a limitation of the size of the display screen of the device, the canvas 604(B) occupies the entire screen, and the window 602(B) indicated by the dotted line cannot be shown. In this example, although not shown in FIG. 6B, the background of the window 602(B) also adopts the image included in the theme pattern 506-3. The color of the background of the canvas 604(B) shown in FIG. 6B is a color extracted from an image included in the theme pattern 506-3. In this example, the exemplary document interface 600(B) is presented on a device with a smaller display screen, such as a mobile phone, palmtop computer, etc.

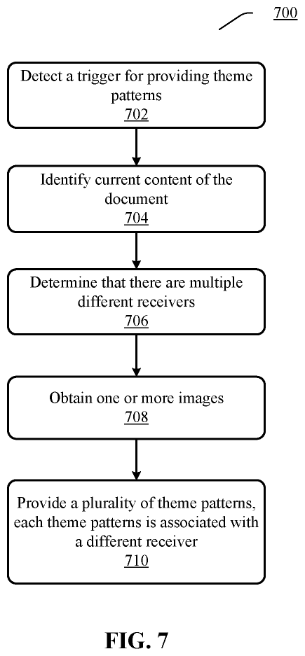

FIG. 7 illustrates an exemplary process 700 for recommending a plurality of theme patterns for a same document according to an embodiment.

At block 702, a trigger for providing theme patterns may be detected, which is similar to operations at blocks 202 and 402. In this embodiment, the process 700 is described with user input to a document as an example of the trigger.

At block 704, current content of the document may be identified in response to detecting trigger, which is similar to operations at blocks 204 and 404.

At block 706, it may be determined that there are a plurality of different receivers of the document. For example, it may be determined that there are a plurality of different receivers of the document according to the information inputted by a creator of the document before creating the document. For example, when the creator of the document activates an application of the document, the creator of the document may be prompted in a form of a prompt box, question and answer, or selection to select receivers or targets of the document, such as “Who is the receiver of the document?” or “Please select the receiver of the document: family, friends, colleagues, or company A, company B, or department D, department E of company C, etc.”. By way of example, and not limitation, if a creator of a document inputs multiple different receivers, such as multiple user IDs, multiple email addresses, in a form of question-and-answer, or select multiple options under selection form, it may be determined that there are multiple different receivers for the document.

At block 708, one or more images may be obtained according to current content of the identified document and/or a profile of the receiver, which is similar to the operations at blocks 208 and 408. In some examples, the obtained image may be retrieved from an image database or generated according to text of the current content of the document. In this example, the obtained image may be attached with a multi-dimensional label, which may include a label about the profile of the receiver, such as the labels “Receiver's ID”, “Receiver's Name”, “A Company to which the receiver belongs”, “A Department to which the receiver belongs”, “A Group to which the receiver belongs”, “Receiver's Email Address”, etc.

At block 710, a plurality of theme patterns related to the current content of the document are provided, where each of the plurality of theme patterns is associated with a different receiver of the document. In some examples, providing a plurality of theme patterns may comprise: providing a plurality of theme patterns according to the obtained one or more images, which is similar to the operations of blocks 210, 410; and each theme pattern corresponding to the image may be assigned with a corresponding label according to a label about the receiver of the document in the multi-dimensional label of each image, for example, when there are multiple receivers belonging to different departments A, B, C, D, etc., each obtained image may have any one or more of labels “department A”, “department B”, “department C”, “department D”, and each theme pattern corresponding to the image is assigned a corresponding label about the receiver of the document.

Further, the provided plurality of theme patterns may be set to a “to be applied” state, and when a document is operated, one theme pattern may be automatically selected from the plurality of “to be applied” theme patterns to be applied to the document. For example, when a creator of a document sends a document to a receiver of the document, one theme pattern corresponding to the profile of the receiver may be automatically selected to be applied to the document according to the profile of the receiver of the document and the labels that the theme pattern has. For example, when a creator of a document sends a document to a receiver of the document through a chatting tool or email, a group that the receiver belongs to may be determined according to the user ID or email address of the receiver of the document, for example, a company or a department within a company that the receiver belongs to, thereby automatically selecting a theme pattern with a label corresponding to the group from a plurality of provided theme modes to apply to the document. For example, if it is determined that the receiver of the document belongs to department A, a theme pattern with a label of “department A” may be selected from a plurality of theme patterns to be applied to the document when the document is operated (such as sending the document or activating the document).

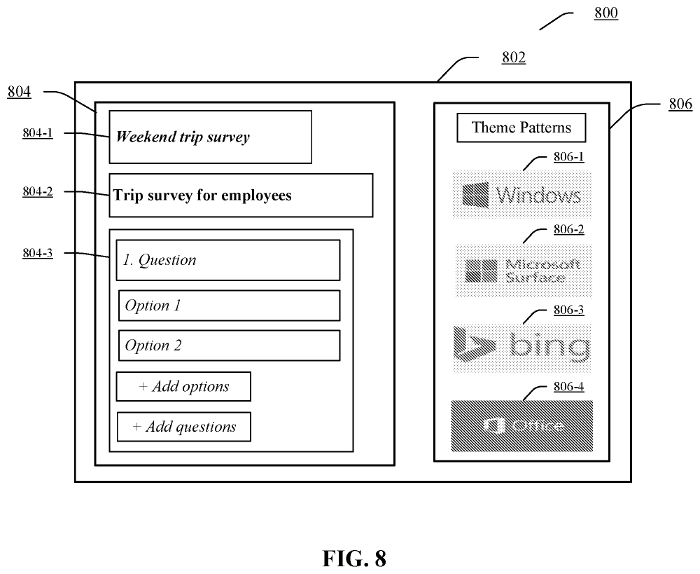

FIG. 8 illustrates an exemplary document interface 800 generated according to the exemplary process of FIG. 7. In this embodiment, a profile of a receiver may indicate that the receiver is an employee of a different department of Microsoft Corporation, such as Windows department, Surface department, Bing department, Office department, etc.

A canvas 804 presenting a document and a window 802 of a theme pattern area 806 is shown in the exemplary document interface 800. In some examples, different elements of the document are shown on the canvas 804, such as a title 804-1 of the document “weekend trip survey”, supplementary description of the title 804-2 “trip survey for employees”, and main body 804-3. It should be understood that the multiple elements shown on the canvas are merely exemplary, and there may be more or fewer elements on the canvas.

According to an identification of a current content on the canvas 804 and further identification of other information of the document, for example, a receiver of the document is an employee of a different department of Microsoft Corporation, one or more images related to the current content and other information may be obtained and corresponding theme patterns, such as 806-1 to 806-4 presented in the theme pattern area 806, may be provided, where each theme pattern is different from employees of different departments of Microsoft Corporation, i.e., associated with a different receiver. It should be understood that although only one associated theme pattern is shown for each receiver in FIG. 8, a list of theme patterns including one or more theme patterns may also be provided or recommended for each receiver.

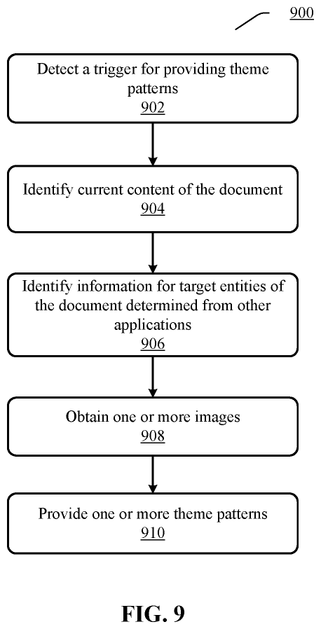

FIG. 9 illustrates still another exemplary process 900 for recommending theme patterns of a document according to an embodiment.

At block 902, a trigger for providing theme patterns may be detected. In this embodiment, the process 900 is described with a document being activated as an example of the trigger.

At block 904, current content of the document may be identified, which is similar to operation at block 204.

At block 906, other information related to the document may be identified, for example, information for target entities of the document determined from other applications. The information for target entities of the document to be created may be determined according to content of other applications. In some examples, target entities for the document may include topics involved in the document, which may include time, place, event, etc., and/or language used in the document, and so on. In some examples, launching of an application of the document or creation of the document may be triggered from other applications, for example, by clicking a link in another application, etc., to jump to the application of the document. For example, if the other application is an email, an application of the document, such as a Form, Excel, Word, PPT, or other types of documents, may be jumped to by clicking a link in the email interface, and a topic of the document to be created or a language used in the document may be determined according to a title or text content or keywords in a main body of the email. For example, if “weekend trip” is mentioned in Chinese in a text content of an email, a topic of a document, such as a form, to be created may be determined, for example, the time is “weekend”, the event is “trip”, etc., and the language used in this document may be determined as Chinese.

At block 908, one or more images may be obtained according to the current content of the identified document and information for the target entity of the document determined from other applications, which is similar to the operation of block 408.

At block 910, a theme pattern may be generated or provided according to the obtained image, which is similar to the operation of block 410.

Further, in some examples, after one or more theme patterns are provided to a user or a creator of the document, the user may select a theme pattern to apply to the document. In other examples, any one of the generated or provided theme patterns or a highest-ranked theme pattern may be directly applied to the document without being provided to the user for selection.

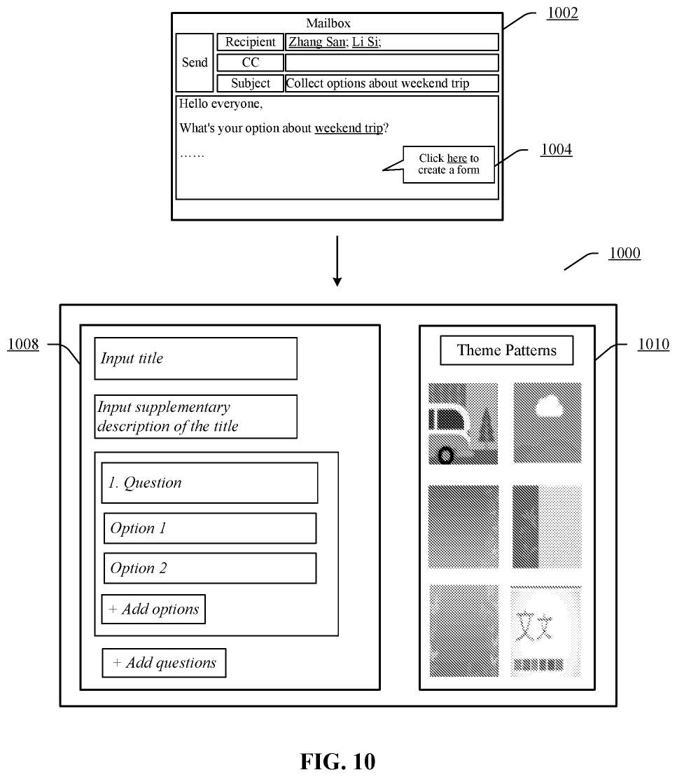

FIG. 10 illustrates an exemplary document interface 1000 generated according to the exemplary process of FIG. 9. In this embodiment, another application is a mail application 1002, and a trigger to provide theme patterns is an activation operation on the document, such as a click on the “creating a form” shown at 1004.

As shown in FIG. 10, information for a target entity of a document such as a form, such as a topic involved in a created form, may be determined according to the content in a mail application. In this example, according to the content of the mail, it may be determined that the topic involved in the form is “weekend trip”. In this example, although the current content of the document is not identified on a canvas 1008 of the document, that is, the current content is “none”, which is only exemplary, in other examples, the current content, such as the title, the supplementary description of the title, and the text of the main body, may be identified on the canvas 1008 of the document. According to the current content in the form and the topics involved in the form determined from the mail, one or more images related to “weekend trip” may be obtained, and corresponding theme patterns 1010 may be provided or recommended.

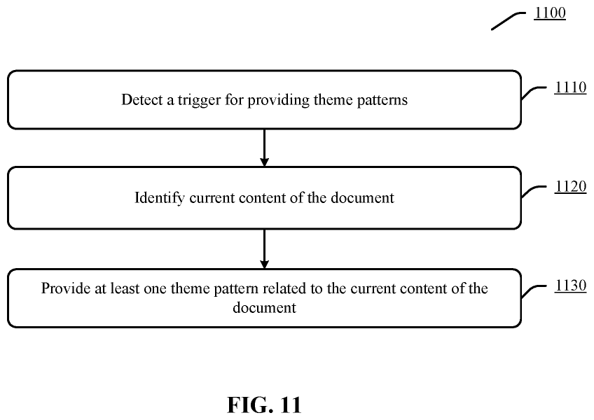

FIG. 11 illustrates a flowchart of an exemplary method 1100 for recommending theme patterns of a document according to an embodiment.

At block 1110, a trigger for providing theme patterns may be detected.

At block 1120, current content of the document may be identified.

At block 1130, at least one theme pattern related to the current content of the document may be provided.

In an implementation, the theme pattern comprises one or more of background of a window of the document, background of a canvas of the document, format of text presented on the canvas, identification presented on the canvas, wherein the identification is associated with at least one of current content of the document, a creator of the document, a receiver of the document.

In an implementation, the method 1100 further comprises: obtaining at least one image at least according to the current content of the document; and generating the at least one theme pattern according to the at least one image.

In a further implementation, the method 1100 further comprises: identifying a change of the current content, wherein the at least one image is obtained further according to the change.

In a further implementation, the method 1100 further comprises: identifying other information related to a document, wherein the other information related to the document includes one or more of a profile of a creator of the document, a history usage record of the creator with respect to theme patterns, a profile of a receiver of the document, and information for target entities of the document determined from other applications, wherein the at least one image is obtained further according to the other information.

In an implementation, identifying other information related to the document further comprises: determining that there are a plurality of different receivers of the document. In a further implementation, providing the at least one theme pattern further comprises: providing a plurality of theme patterns related to the current content of the document, wherein each of the plurality of theme patterns is associated with a receiver in the plurality of different receivers.

In an implementation, the at least one image is retrieved from an image database or generated according to text of the current content of the document.

In an implementation, generating the at least one theme pattern further comprises: generating, according to the at least one image, one or more of background of a window of the document, background of a canvas of the document, and format of text of the document.

In a further implementation, the trigger comprises one or more of an activation operation to the document, an editing operation to text of the document, and reception of a request for providing theme patterns.

In an implementation, the current content of the document comprises one or more of: text of the document, format of text of the document, topic involved in the document, and language used in the document.

In a further implementation, the method 1100 further comprises: applying one of the at least one theme pattern to the document.

It should be understood that the method 1100 may further include: any step/process for recommending theme patterns of a document according to the embodiments of the disclosure as mentioned above.

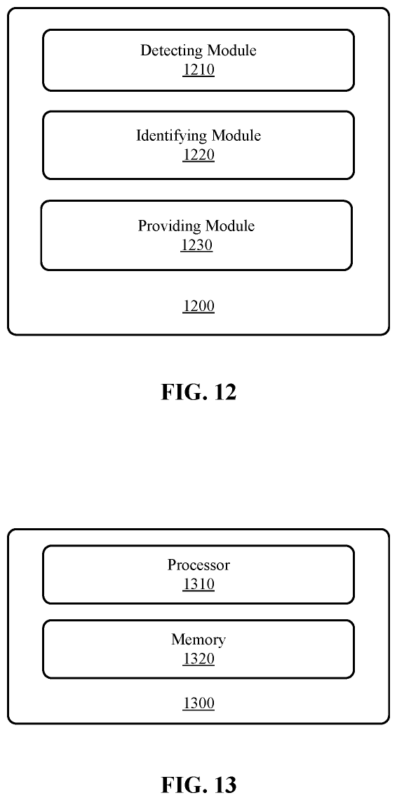

FIG. 12 illustrates an exemplary apparatus 1200 for recommending theme patterns of a document according to an embodiment.

The apparatus 1200 may comprise: a detecting module 1210, for detecting a trigger for providing theme patterns; an identifying module 1220, for identifying current content of the document; and a providing module 1230, for providing at least one theme pattern related to the current content of the document.

In an implementation, the theme pattern comprises one or more of background of a window of the document, background of a canvas of the document, format of text presented on the canvas, identification presented on the canvas, wherein the identification is associated with at least one of current content of the document, a creator of the document, a receiver of the document.

In an implementation, the apparatus 1200 further comprises: an obtaining module, for obtaining at least one image at least according to the current content of the document; and a generating module, for generating the at least one theme pattern according to the at least one image.

In an implementation, the identifying module is further for identifying a change of the current content. In a further implementation, the at least one image is obtained further according to the change.

In an implementation, the identifying module is further for identifying other information related to the document, wherein the other information related to the document includes one or more of a profile of a creator of the document, a history usage record of the creator with respect to theme patterns, a profile of a receiver of the document, and information for target entities of the document determined from other applications. In a further implementation, the at least one image is obtained further according to other information.

In an implementation, the identifying module 1220 is further for determining that there are a plurality of different receivers of the document. In a further implementation, the providing module 1230 is further for: providing a plurality of theme patterns related to the current content of the document, wherein each of the plurality of theme patterns is associated with a receiver in the plurality of different receivers.

In an implementation, the trigger comprises one or more of an activation operation to the document, an editing operation to text of the document, and reception of a request for providing theme patterns.

In an implementation, the current content of the document comprises one or more of: text of the document, format of text of the document, topic involved in the document, and language used in the document.

It should be understood that the apparatus 1200 may further include: any other modules configured for recommending theme patterns of a document according to the embodiments of the disclosure as mentioned above.

FIG. 13 illustrates another exemplary apparatus 1300 for recommending theme patterns of a document according to an embodiment. The apparatus 1300 may comprise one or more processors 1310 and a memory 1320 storing computer-executable instructions that, when executed, cause the one or more processors 1310 to: detect a trigger for providing theme patterns; identify current content of the document; and provide at least one theme pattern related to the current content of the document.

Embodiments of the present disclosure may be implemented in a non-transitory computer readable medium. The non-transitory computer readable medium may include instructions that, when executed, cause one or more processors to perform any operation of a method for recommending theme patterns of a document according to embodiments of the disclosure as described above.

It should be appreciated that all the operations in the methods described above are merely exemplary, and the present disclosure is not limited to any operations in the methods or sequence orders of these operations, and should cover all other equivalents under the same or similar concepts. It should also be appreciated that all the modules in the apparatuses described above may be implemented in various approaches. These modules may be implemented as hardware, software, or a combination thereof. Moreover, any of these modules may be further functionally divided into sub-modules or combined together.

The term “exemplary” used in this application means serving as an example, illustration, or description. Any embodiment or design described as “exemplary” in this application should not be construed as preferred or advantageous over other embodiments or designs. Rather, the use of an exemplary term is intended to convey the idea in a specific manner. The term “or” used in this application means an inclusive “or” rather than an exclusive “or”. That is, “X uses A or B” means any natural inclusive permutation unless otherwise specified or clear from the context. That is, if X uses A, X uses B, or X uses both A and B, “X uses A or B” satisfies any of the above examples. In addition, “a” and “an” items used in this application and the appended claims usually mean “one or more”, unless otherwise specified or clear from the context that it is a singular form.

Processors are described in connection with various apparatus and methods. These processors may be implemented using electronic hardware, computer software, or any combination thereof. Whether these processors are implemented as hardware or software will depend on the specific application and the overall design constraints imposed on the system. By way of example, a processor, any portion of a processor, or any combination of processors presented in this disclosure may be implemented as a microprocessor, a micro-controller, a digital signal processor (DSP), a field programmable gate array (FPGA), a programmable logic device (PLD), state machine, gate logic, discrete hardware circuitry, and other suitable processing components configured to perform the various functions described in this disclosure. The functions of a processor, any portion of a processor, or any combination of processors presented in this disclosure may be implemented as software executed by a microprocessor, a micro-controller, a DSP, or other suitable platforms.

Software should be considered broadly to represent instructions, instruction sets, code, code segments, program code, programs, subroutines, software modules, applications, software applications, software packages, routines, subroutines, objects, running threads, processes, functions, and the like. Software may reside on computer readable medium. Computer readable medium may include, for example, a memory, which may be, for example, a magnetic storage device (e.g., a hard disk, a floppy disk, a magnetic strip), an optical disk, a smart card, a flash memory device, a random access memory (RAM), a read only memory (ROM), a programmable ROM (PROM), an erasable PROM (EPROM), an electrically erasable PROM (EEPROM), a register, or a removable disk. Although a memory is shown as being separate from the processor in various aspects presented in this disclosure, a memory may also be internal to the processor (e.g., a cache or a register).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are intended to be encompassed by the claims.

1. A method for recommending theme patterns of a document, comprising:
detecting a trigger for providing theme patterns;
identifying current content of the document; and
providing at least one theme pattern related to the current content of the document.

2. The method of claim 1, wherein the theme patterns comprise one or more of:
background of a window of the document;
background of a canvas of the document;
format of text presented on the canvas;
identification presented on the canvas, wherein the identification is associated with at least one of the current content of the document, a creator of the document, and a receiver of the document.

3. The method of claim 1, further comprising:
obtaining at least one image at least according to the current content of the document; and
generating the at least one theme pattern according to the at least one image.

4. The method of claim 3, further comprises:
identifying a change of the current content,
wherein the at least one image is obtained further according to the change.

5. The method of claim 3, further comprising:
identifying other information related to the document, wherein the other information related to the document includes one or more of a profile of a creator of the document, a history usage record of the creator with respect to theme patterns, a profile of a receiver of the document, and information for target entities of the document determined from other applications,
wherein the at least one image is obtained further according to the other information.

6. The method of claim 5, wherein,
identifying other information related to the document further comprises: determining that there are a plurality of different receivers of the document; and
providing the at least one theme pattern further comprises: providing a plurality of theme patterns related to the current content of the document, wherein each of the plurality of theme patterns is associated with a receiver in the plurality of different receivers.

7. The method of claim 3, wherein the at least one image is retrieved from an image database or generated according to text of the current content of the document.

8. The method of claim 3, wherein generating the at least one theme pattern further comprises: generating, according to the at least one image, one or more of background of a window of the document, background of a canvas of the document, and format of text of the document.

9. The method of claim 1, wherein the trigger comprises one or more of an activation operation to the document, an editing operation to text of the document, and reception of a request for providing theme patterns.

10. The method of claim 1, wherein the current content of the document includes one or more of:
text of the document,
format of the text of the document,
keywords in the document, and
language used in the document.

11. The method of claim 1, further comprising:
applying one of the at least one theme pattern to the document.

12. An apparatus for recommending theme patterns of a document, comprising:
a detecting module, for detecting a trigger for providing theme patterns;
an identifying module, for identifying current content of the document; and
a providing module, for providing at least one theme pattern related to the current content of the document.

13. The apparatus of claim 12, further comprising:
an obtaining module, for obtaining at least one image at least according to the current content of the document; and
a generating module, for generating the at least one theme pattern according to the at least one image.

14. The apparatus of claim 13, wherein the identifying module is further for identifying a change of the current content, and the at least one image is obtained further according to the change.

15. An apparatus for recommending theme patterns of a document, comprising:
one or more processors; and
a memory storing computer-executable instructions that, when executed, cause the one or more processors to:
detect a trigger for providing theme patterns;
identify current content of the document; and
provide at least one theme pattern related to the current content of the document.
